(19) United States
(12) Patent Application Publication
(10) Pub. No.: US 2003/0010561 A1
(43) Pub. Date: Jan. 16, 2003

(54) Low load floor motor vehicle

(76) Inventor: James J. Bartel, Commerce, MI (US)

Correspondence Address: HARNESS, DICKEY & PIERCE, P.L.C., P.O. BOX 828, BLOOMFIELD HILLS, MI, 48303, US

(21) Appl. No.: 10/175,355

(22) Filed: Jun. 18, 2002

Related U.S. Application Data
(63) Continuation-in-part of application No. 09/710,720, filed on Nov. 9, 2000.

(51) Int. Cl. B60K 5/00; B60K 17/22

(52) U.S. Cl. 180/292

(57) ABSTRACT

The present invention provides a front engine/rear drive vehicle, such as a medium-sized bus, having a power transfer device and a sloped lower load floor. The power transfer means enables advantageous packaging of a drive shaft for driving a rear-positioned drive. The sloped lower load floor provides a continuously flat load floor without requiring a step over a differential area. Further the sloped lower load floor enables lower ground clearance at a front portion for implementation of a manageable wheelchair access ramp, as opposed to an expensive elevator system. Additionally, the sloped lower load floor provides sufficient rear ground clearance for managing inclines and is kneelable enabling easier load/unload access to the rear of the vehicle.

### CROSS-REFERENCE TO RELATED APPLICATIONS

This application is a continuation-in-part of U.S. patent application Ser. No. 09/710,720 filed on Nov. 9, 2000.

### TECHNICAL FIELD

This invention relates to a low load floor motor vehicle and more particularly a low load floor vehicle that has a unique power train, a unique suspension and a forward, downwardly sloping floor which is kneelable. This low load floor vehicle has special application as a medium duty bus and delivery truck.

### BACKGROUND OF THE INVENTION

The advantages of having a passenger or cargo vehicle with a flat load floor are well known. Heavy-duty trucks usually have longitudinally mounted front engines and rear drives. A flat load floor is obtained with such vehicles by raising the load floor to a sufficient height to clear all obstructions beneath the load floor. One particularly large under-floor obstruction for a heavy truck is its power-train differential. The load floor height can be approximately about four feet. Heavy-duty busses obtain a somewhat lower flat floor area in the forward part of the bus by providing a transversely mounted rear engine that drives rear wheels. The complexities of such a drive make it expensive. As to smaller vehicles, such as medium duty trucks and busses, it is also desirable to have a low load floor, as well as a flat load floor. A low step height into the vehicle makes the vehicle much more accessible for loading both passengers and cargo. However, in smaller vehicles, including medium duty busses and trucks, a rear engine/rear drive power package is not a commercially viable option.

It is well known that one can obtain a low flat load floor in a vehicle by disposing the vehicle engine and power train wholly in the front of the vehicle. Such vehicles are already commercially available. Such a vehicle can provide a low step height to the load floor that makes the vehicle much more accessible for loading both passengers and cargo. However, the utility of such vehicles is limited because the driving wheels are not located under the part of the vehicle carrying the load. Improved weight balance and load-carrying capacity is achieved if the engine is in the front of the vehicle and the driving wheels are in the back of the vehicle, under the load. Further, other deficiencies of such vehicles include a limited durability and reduced turning angle of the front axle.

Because of low load floor front drive trucks and busses have practical limitations, there is still interest in finding an economical rear drive truck and bus that has a low load floor. In addition, disposing the vehicle engine in the front of the vehicle leaves the back of the vehicle more available for passengers and/or cargo. Further, it should be understood that extensive worldwide manufacture and sales of front-engine/rear drive trucks and buses has provided a vast engineering and use experience with front engine/rear drive power trains. This vast experience has provided the lowest cost and highest durability for such power trains. For these and other reasons, there is continued manufacture and use of front-engine/rear drive trucks and buses, even though their load floors are relatively high. Because of this extensive production and use experience, there continues to be interest in utilizing front engine/rear drive power trains for low profile and/or low load floor vehicles.

It would be of considerable commercial advantage if a low and flat load floor vehicle could be made using mostly traditional front engine/rear drive components. If so, the traditional components would be useful in the manufacture of both the traditional and the low profile vehicles. It would be of even greater advantage if the low load floor vehicle and the traditional vehicle were generally the same forward of the load floor. This will tend to reduce development costs of the low profile vehicle, and make it manufactureable at lower cost and higher durability.

### SUMMARY OF THE INVENTION

It is an object of the present invention to provide a low load floor vehicle that is flat along its length.

It is another object of the present invention to provide a low load floor vehicle that may be adjusted to provide sufficient ground clearance.

It is a further object of the present invention to provide a low load floor vehicle having sufficient sub-floor stopface space for storing fuel containers, air conditioners and the like.

One aspect of the present invention contemplates a vehicle having a conventional in-line front engine, a conventional transmission, a step down power transfer case on the rear of the transmission, and a conventional drive shaft extending towards the vehicle rear. The drive shaft extends to a frame-mounted differential that has opposed half-shaft axles, sometimes referred to simply as half-shafts, extending to rear wheels on opposite sides of the vehicle. The lowered rear output of the step down transfer case and a fixed location of the differential allows the load floor of the vehicle to be very low and flat between the step down transfer case and the differential.

The step down transfer case is belt, chain or gear driven and differs from a four-wheel drive transfer case in providing a rear output at a level closer to the roadway. The drive shaft can now even be lower in the front than in the rear, and preferably is segmented, depending upon the design wheelbase of the vehicle. The lowered rear output of the step down transfer case and a fixed location of the differential allows the load floor of the vehicle to be very low.

It is currently preferred to interpose the step-down transfer case as an adaptor module between a conventional manual or automatic transmission and a drive shaft. However, it is recognized that in due course, it may be desirable to integrate the step down feature with the transmission.

In a preferred example, the low load floor slopes downward from the rear toward the front of the vehicle to provide sufficient rear clearance without requiring a step over the differential area. This enables sufficient rear ground clearance, whereby the vehicle may enter inclines without having its rear strike the roadway.

A low profile rear suspension system is also provided and includes trailing arms fixed at a first end to torque rods and extend for attachment at a second end to the rear half-shaft axles. Twisting of the torque rods enable resilient support of the trailing arms and thus the axles.

Lowest load floors are attained by also using the low profile rear suspension system in combination with geared wheel drives on the out board ends of the half-shaft axles. The geared wheel drives split the final drive ratio with the differential, to allow use of a smaller diameter ring gear in the differential. The result is that the differential is smaller, which allows a lower load floor over the differential.

In a special embodiment of the present invention, a special low profile trailing arm suspension system is used for the rear wheels that allows use of air springs. The air springs can be deflated when the vehicle is parked, to lower rear load floor height. When the rear of the vehicle is so lowered, its load floor is made more accessible.

### BRIEF DESCRIPTION OF THE DRAWINGS

Further objects, features and advantages of the present invention will become apparent from analysis of the following written specification, the accompanying drawings, and the appended claims in which:

FIG. 1 is a schematic side view of a prior art conventional front engine/rear drive medium duty truck or bus;

FIG. 2 is a schematic side view of the FIG. 1 medium duty truck/bus modified to include a step-down power transfer case of this invention, a fixed mount half-shaft differential, and a lowered load floor;

FIG. 3 is an elevational enlarged sectional side view of the step down transfer case included in the truck shown in FIG. 2;

FIG. 4 is a cross-sectional view taken along the line 4-4 of FIG. 3 showing a chain drive internal power transfer connection between the transfer case input and output shafts;

FIG. 5 is a cross-sectional view of a first gear drive alternative embodiment of the internal power transfer connection shown in FIG. 4;

FIG. 6 is a cross-sectional view of a second gear drive alternative embodiment of the internal power transfer connection shown in FIG. 4;

FIG. 7 is a cross-sectional view of a belt drive alternative embodiment of the internal power transfer connection shown in FIG. 4;

FIG. 8 is a schematic side view of an alternative embodiment of the FIG. 2 truck/bus in which a torque converter is interposed between the in-line front engine and transmission;

FIG. 9 is a schematic side view of another alternative embodiment of the FIG. 2 truck/bus in which the step-down power transfer case is integrated with the vehicle transmission;

FIG. 10 is a schematic side view of still another alternative embodiment of the FIG. 2 truck/bus in which the step down power transfer case is integrated with a torque converter;

FIG. 11 is a schematic side view of somewhat higher load floor alternative embodiment of the FIG. 2 truck/bus in which the vehicle combines the step-down power transfer case with a rigid differential/axle unit and longitudinal leaf springs;

FIG. 12 is a schematic top view of the power train of the truck/bus shown in FIG. 11, with leaf springs shown and other vehicle parts shown in phantom lines for points of reference;

FIG. 13 is a schematic side view of a lower load floor embodiment of this invention that includes a low profile torsion bar trailing arm rear suspension in addition to a power train having a half-shaft differential and swing axles that directly drive rear wheels;

FIG. 14 is a schematic top view of the power train of the truck/bus shown in FIG. 13, with suspension trailing arms shown and other vehicle parts shown in phantom lines for points of reference;

FIG. 15 is an enlarged schematic rear end view along the line 15-15 of FIG. 14;

FIG. 16 is a schematic side view of the lowest load floor vehicle example described herein, and shows a vehicle having the step-down power transfer case, a low profile half-shaft differential, gear drives at axle outer ends, and a specially low profile trailing arm rear suspension;

FIG. 17 is a schematic end view along the line 17-17 of FIG. 16;

FIG. 18 is a schematic end view along the line 18-18 of FIG. 16;

FIG. 19 is a schematic view along the line 19-19 of FIG. 17, showing the interior of the gear drive at wheel end of axle, and the mounting of the gear drive on a vertical plate extending up from the suspension trailing arm;

FIG. 20 is a schematic side view of a slopping lower load floor embodiment in a normal operating position;

FIG. 21 is a schematic side view of the sloping lower load floor of FIG. 20 is a kneeled position;

FIG. 22 is a plan view of the sloping lower load floor embodiment;

FIG. 23 is a detailed side view of a differential area of the sloped lower load floor;

FIG. 24 is a cross-sectional view of the differential along line 24-24 of FIG. 22, detailing interconnecting frame components;

FIG. 25 is a schematic view of a lower load floor having a side slope;

FIG. 26 is a schematic view of a lower floor having a side slope in a kneeled position; and

FIG. 27 is the schematic end view of FIG. 18 detailing a panhard rod configuration; and

FIG. 28 is a schematic end view of FIG. 18 detailing a Watts link configuration.

### DESCRIPTION OF EXEMPLARY EMBODIMENTS

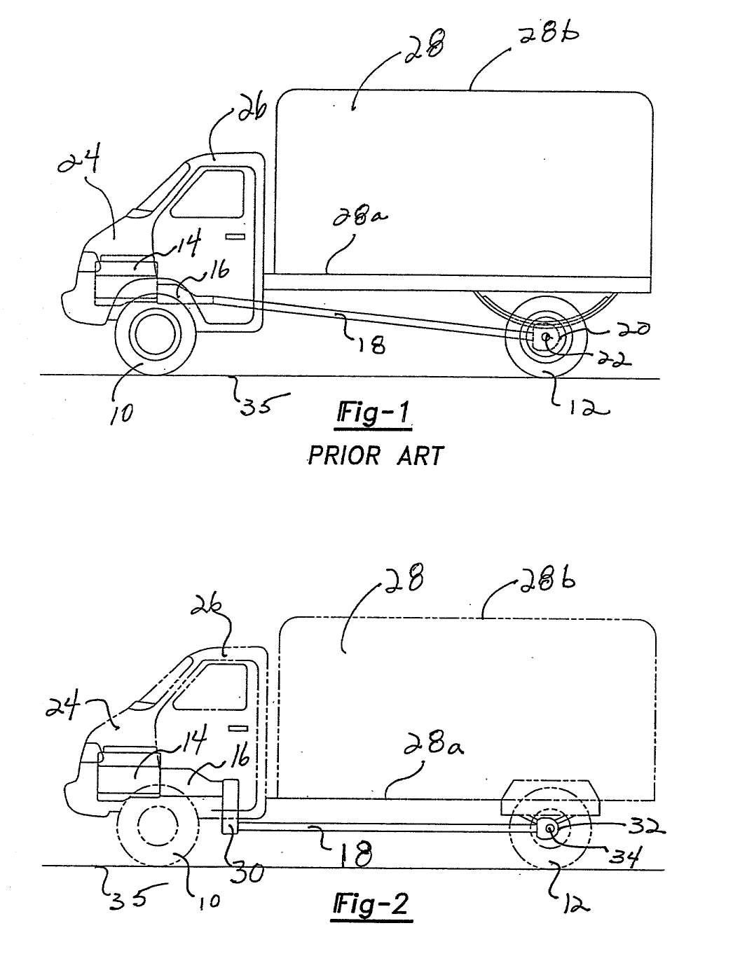

Referring to the drawings wherein like characters represent the same or corresponding components, FIG. 1 shows a conventionally powered vehicle such as a truck or bus. If a truck, it is preferably a medium duty truck, which has gross vehicle weights of about 11,000 lb. to 33,000 lb. If it is a bus, it is small to mid-sized bus, as for example a bus having an overall length of about 15 feet up to about 30 feet. By the expression medium duty truck/bus, is meant to include such busses, as well as such a medium duty truck. The prior art truck/bus of FIG. 1 has front wheels 10 and rear wheels 12 that support the vehicle on a roadway 35. Rear wheels 12 are conventionally powered by an internal combustion engine 14, acting through a transmission 16, a drive shaft 18, a differential 20, and axles 22 (only one of which is shown in FIG. 1). The typical truck/bus has an engine compartment 24, a driver's cab 26, and a load-carrying compartment 28. Compartment 28 has a flat load floor 28a that is disposed in a plane not only above differential 20 but also even above the forward end of the drive shaft 18. FIG. 1 shows drive shaft 18 as a single segment. In some other prior art truck/bus vehicles, load floor 28a may be lowered somewhat by using a segmented drive shaft that has an intermediate universal joint. However, using the intermediate universal joint adds cost and another failure site to the vehicle. It is generally accepted that for greatest durability, a single segment drive shaft is preferred. Many embodiments of the present invention allow use of a single segment drive shaft, even though the embodiments are vehicles with low load floors.

In the prior art typical truck/bus, the internal combustion engine 14 is conventionally longitudinally mounted in an engine compartment 24 forward of the driver's cab 26 of the truck/bus. By longitudinally mounted, it is meant that the length of the engine, i.e., the rotation axis of its crankshaft, is in-line with the length of the vehicle, instead of being transverse to the length of the vehicle. Transmission 16 is disposed at the rear of engine 14. It can be directly attached to engine 14 as shown, or to a torque converter that is directly attached to engine 14, as is seen in FIG. 8. Power output from engine 14 is thus input directly or indirectly into transmission 16. The forward end of a drive shaft 18 is connected, usually by means of a universal joint (not shown), to the rear power output of transmission 16. The rearward end of drive shaft 18 is in turn connected to differential 20, usually by means of a universal joint (not shown). Opposed axles 22, only one of which can be seen in FIG. 1, extend outwardly from differential 20 to the rear wheels 12, only one of which can be seen in FIG. 1. Typically, axles 22 are respectively housed in opposed torque tubes (not shown) extending out from opposed sides of differential 20. The torque tubes are rigidly affixed to the opposed sides of differential 20, as shown in FIG. 12. Axles 22 are thus rigidly supported so that they rotate in a fixed position with respect to differential 20. For ease of illustration, the torque tubes are not shown in FIG. 1. However, it should be understood that in this type of prior art rear drive, differential 20 and axles 22 ordinarily form a rigid unitary assembly that is spaced from the vehicle load floor 28a or from the vehicle frame (not shown) by a suspension system. In the following discussion the rigidly supported axles 22 and their covering torque tubes are referred to as axles interchangeably. The suspension system is supported by the rigid differential/axle assembly, and in turn resiliently supports the load floor or frame of the vehicle.

The vehicle of FIG. 1 usually carries its load relatively high up on the vehicle, especially if it is desired to have a flat load floor 28a. When flat load floors are desired, the power train alone can make the vehicle have a high load floor 28a. Rear suspension systems can contribute to load floor height too. In medium trucks, load floor height can be four to five feet high. In typical school buses, load floor height is over three feet high. In smaller mid sized busses and delivery trucks, as for example local area busses used at airports and express package delivery trucks, load floor height is often three significant steps high, which is often about 32-40 inches high. Such a height is clearly undesirable. For example, it precludes ready access by passengers, especially elderly or disabled passengers. It makes loading heavy personal items, such as luggage, difficult and slow. It slows loading and unloading of delivery packages by delivery personnel, etc. It should also be mentioned that it is fatiguing to a delivery person to repeatedly ascend and descend the vehicle steps numerous times per day. This can not only slow other aspects of delivery times but can lead to work related injuries for delivery personnel. Also, in package delivery vehicles, a significant inside height is desired for load compartment 28. If load floor 28a is high, this dictates that the top 28b of compartment 28 be correspondingly high. This height can easily make the delivery vehicle too tall to enter a commercial building's underground garage, where there is ready access to building elevators. Lack of such ready access to delivery sites can further slow average delivery time, increase delivery fatigue, and unnecessarily subject delivery personnel and the packages they carry to undesirable weather conditions. In addition, a tall vehicle has a larger frontal area, which can increase operating costs by reducing vehicle fuel mileage.

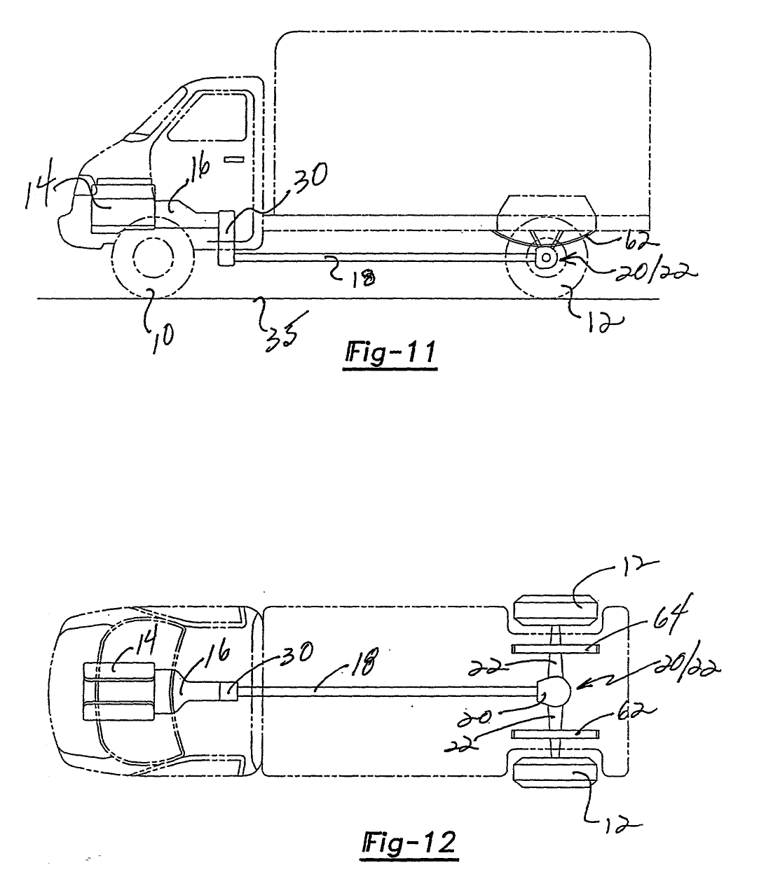

An initial embodiment of the improved vehicle of the present invention is shown in FIG. 2 as a medium duty truck/bus. This initial embodiment of the invention is easily distinguished from the prior art typical medium duty truck/bus of FIG. 1 by its lower load floor 28a, which allows top 28b on load compartment 28 to be lower. Lower top 28b gives the vehicle a lower profile overall. The lower load floor 28a has fewer steps (not shown) up to the load floor 28a. In its most preferred embodiment, shown in FIGS. 11-12 and 15-16, the medium duty truck/bus can have a load floor 28a as low as only 16-18 inches above the road surface (not shown) under wheels 10 and 12. At least one step up to the load floor 28a is eliminated. As indicated above, fewer steps up to the load floor benefits deliveries and delivery personnel for trucks, and passengers for busses. Also as indicated above, the lower vehicle profile permits access to more underground garages and can enhance vehicle gas mileage. In the city, busses often pick up passengers from a curb. Curbs are typically about six inches high. It is contemplated that a forward section of a city bus can be configured to have a load floor of only about 14-16 inches above the roadway, so that the step up from the curb would be only about eight inches or less. This permits the city bus to use a simple, inexpensive, quick acting and durable ramp to load disabled passengers, instead of an expensive, non-durable, and slow acting complex lift system. Such a ramp can also be a significant aid to airport bus passengers burdened with heavy luggage.

As indicated above, FIG. 2 shows a vehicle that can be either a truck or a bus like the vehicle of FIG. 1. If a truck, it is preferably a medium duty truck, which involves gross vehicle weights of about 11,000 lbs. to 33,000 lbs. If it is a bus, it is a small to mid-sized bus, as for example a bus having an overall length of about 15 feet up to about 30 feet. As indicated above, the expression medium duty truck/bus, It is meant to include such busses, as well as such medium duty trucks. Like the truck/bus of FIG. 1, the truck/bus of FIG. 2 has front wheels 10 and rear wheels 12. Rear wheels 12 are powered by an internal combustion engine 14, acting through a transmission 16, a step-down power transfer case 30, a drive shaft 18, a half-shaft differential 32, and swing axles 34 (only one of which is shown in FIG. 2). Engine 14 is longitudinally mounted in an engine compartment 24 in the front of the vehicle. Behind the engine compartment is a driver's cab 26, followed by a load-carrying compartment 28. As in the FIG. 1 prior art truck/bus, engine 14 is conventionally longitudinally mounted, with transmission 16 disposed at the rear of engine 14. Also as in the prior art truck/bus of FIG. 1, transmission 16 can be directly attached to engine 14 as shown, or to a torque converter that is directly attached to the rear of engine 14. Power from engine 14 is thus input directly or indirectly into transmission 16.

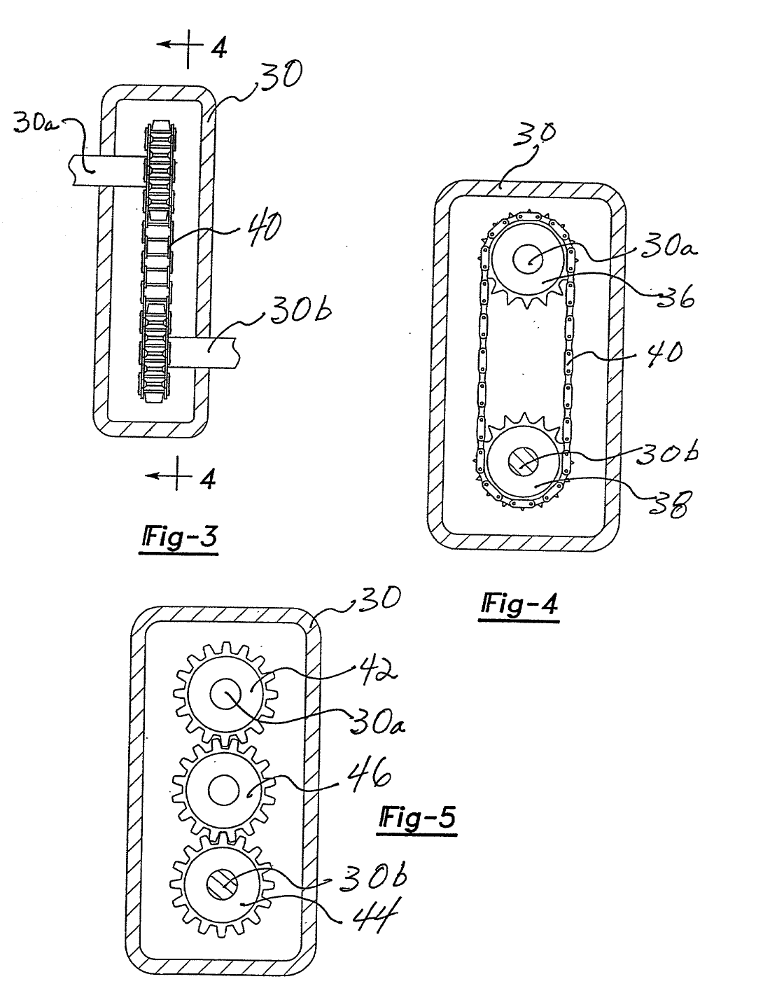

Referring now to FIGS. 3 and 4 as well as to FIG. 2, the step-down power transfer case 30 has a power input shaft 30a on its forward face and a power output shaft 30b on its rearward face. Power input shaft 30a is at or near the top of the front face of transfer case 30. Power output shaft 30b is at or near the bottom of the rear face of transfer case 30. Transfer case 30 is referred to as a step-down transfer case. Power input shaft 30a is connected to the rear power output of transmission 16. Power output shaft 30b is connected to the forward end of drive shaft 18, usually by means of a universal joint (not shown). It can be seen that this point of connection is much lower on the vehicle than the point of connection between drive shaft 18 and transmission 16 in the conventional prior art truck/bus of FIG. 1.

The rearward end of drive shaft 18 is in turn connected to differential unit 32 by a universal joint, as in the prior art vehicle of FIG. 1. However, in this preferred embodiment, differential 32 differs from the differential 20 typically used in the prior art truck/bus shown in FIG. 1. In FIG. 2, differential 32 is a half-shaft differential that is directly affixed to load floor 28a or to the truck/bus frame (not shown). Thus, unlike differential 20 of FIG. 1, differential 32 is not spaced from the load floor 28a or the vehicle frame by a rear wheel suspension system. By half-shaft differential 32, it is meant any differential that has axles connected to it in a manner that allows the outer ends of the axles to move up and down without the differential also moving up and down. The connection is typically by a universal joint. Accordingly, a further difference in the FIG. 2 vehicle from the FIG. 1 vehicle is that the FIG. 2 vehicle has opposed swing axles 34 (only one of which is shown in FIG. 2). By swing axles, it is meant an axle that is connected to the differential by a movable joint, as for example a universal joint. Swing axles 34 are not rigidly held in torque tubes that are in turn rigidly affixed to their associated differential. Instead, they are connected at their inboard ends to half-shaft differential 32 by universal joints. Accordingly, the outboard ends of swing axles 34 are free to move up and down with respect to differential 32. Repeating, they are not rigidly connected to differential 32 and do not form a rigid unitary assembly with differential 32.

Axles 22 are rotatably supported near their outboard ends by bearings in housings that support the rear wheel suspension system (not shown). The rear wheel suspension system can be disposed between the outboard axle supports (not shown) and the load floor 28a. A rear wheel 12 is connected to the extreme outboard end of each of axles 34. Axles 34 and differential 32 thus differ from the suspended unitary rigid differential/axle assembly of FIG. 1. Other vehicle configurations are contemplated, which can lower the load floor even more, and are preferred for many applications. Such alternative configurations shall hereinafter be described.

It can be seen in FIG. 2 that the improved vehicle has a load compartment 28 with a flat load floor 28a that is disposed in a plane only slightly above the half-shaft differential 32. However, it is still also above the forward end of the drive shaft 18. Even though the FIG. 2 flat load floor 28a is quite low, drive shaft 18 can still be a single segment drive shaft, which is preferred. Importantly, it should be seen that drive shaft 18 is not directly connected to the rear of transmission 16. Instead, it is connected to a step-down power transfer case 30, that is disposed in the vehicle drive line between transmission 16 and the forward end of drive shaft 18. Step-down power transfer case 30 can be analogous to a four-wheel drive power transfer case, and analogously mounted. On the other hand, step-down power transfer case 30 differs from a four-wheel drive transfer case in that it is a simpler mechanism, and provides a rear power output 30b much closer to the roadway 35. Hence, its power output 30b to rear wheels 12 is in a plane considerably below that of the transmission power output. The reason for this latter difference is that in four-wheel drive power transfer cases, the lowest power output goes forward to the front wheels. For this and still other reasons, the rear power output of the four-wheel drive transfer case is high up on the rear face of the transfer case, often in-line with its power input from transmission 16. In contrast, rear power output 30b of the transfer case 30 can be as low as one desires. If not much ground clearance is needed, rear power output 30b might only be 3-6 inches above road surface 35. In summary, the power transfer case 30 provides a significantly dropped driveline to rear wheels 12. With the dropped driveline, drive shaft 18 often need not be segmented even though load floor 28a is made to be quite low. The fullest effect in lowering the load floor 28a, however, requires some additional modifications to the power train and to the rear suspension that will hereinafter be described.

However, more details of the step-down power transfer case 30 and of some vehicle permutations shall be first described. Reference is now specifically made to FIGS. 3 and 4, which show enlarged sectional views of the step-down power transfer case 30 shown in FIG. 2. Power input shaft 30a extends through the forward wall of case 30. Power output shaft 30b extends through the rearward wall of case 30. Inside case 30, the ends of shafts 30a and 30b respectively carry toothed wheels 36 and 38. An endless chain 40 encircles toothed wheels 36 and 38 to provide a power connection between input and output shafts 30a and 30b inside case 30. In summary, the driving means interconnecting input shaft 30a to output shaft 30b in this embodiment of the invention is a chain drive, formed by toothed wheels 36 and 38 and by chain 40.

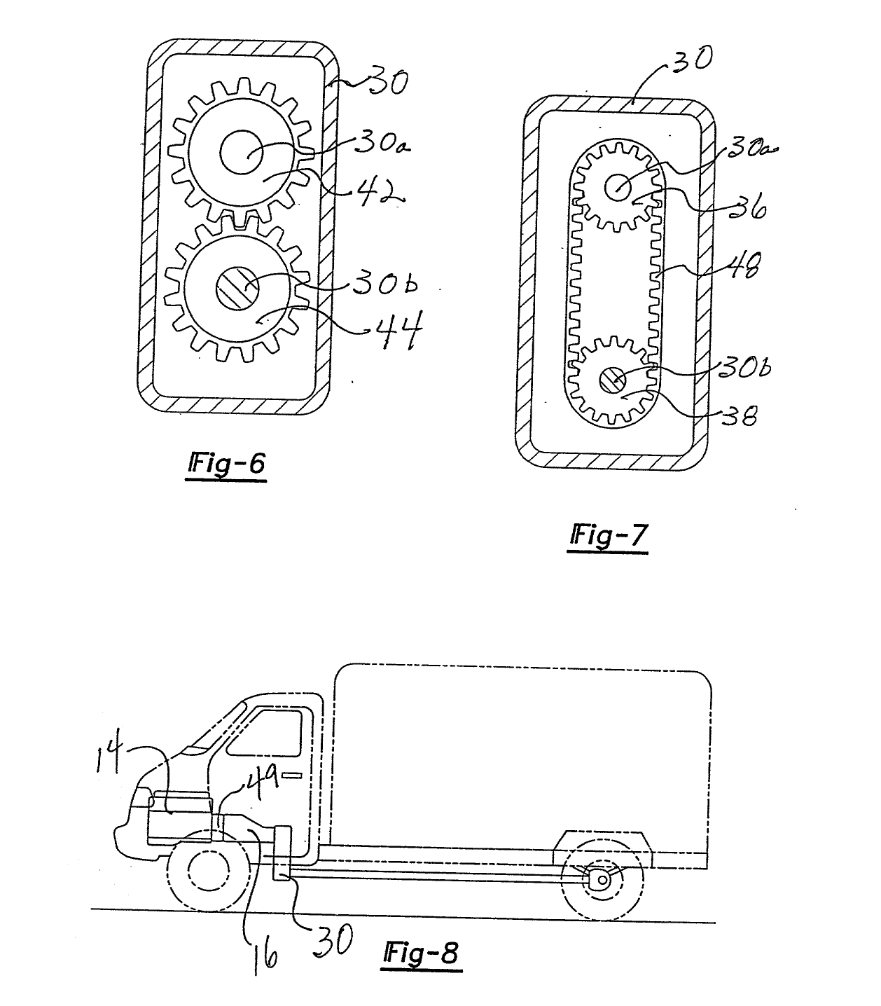

FIGS. 5 and 6 show sectional views analogous to that of FIG. 4 but of alternative embodiments of the chain drive of FIGS. 3-4. In FIG. 5, the toothed wheels 36 and 38 of FIGS. 3-4 are respectively replaced by gears 42 and 44. Gears 42 and 44 mesh with an intermediate gear 46 to obtain a power connection between input shaft 30a and output shaft 30b. Accordingly, it might be said that intermediate gear 46 replaces chain 40 of FIGS. 3-4. In FIG. 6, gears 42 and 44 are shown meshing directly with one another. Such a direct meshing may have the advantage of using bigger gears to vertically space input shaft 30a and output shaft 30b but it reverses rotation of gear 44 from gear 42. This reverses rotation of shaft 30b from shaft 30a. Accordingly, direct meshing of gears 42 and 44 may not be preferred in many cases. Additional intermediate gears (not shown) to intermediate gear 46 might be used to expand the distance between gears 42 and 44. Use of intermediate gears such as intermediate gear 46, and/or sizing the gears can be used to produce any desirable vertical length for case 30, which effectively lowers the output shaft 30b to any desired level. However, in many instances It is preferable to have fewer gears, not more gears, in order to utilize larger gear teeth to handle more power.

FIG. 7 shows a cog belt drive alternative connection between input and output shafts 30a and 30b of case 30. Toothed wheels 36 and 38 of FIGS. 3-4 engage an endless belt 48, instead of chain 40. This alternative would not typically be preferred as it cannot handle as much load as a chain or gear drive. It is only included to illustrate that alternatives to the preferred gear and chain drives are possible.

In FIG. 8, a vehicle is shown that is similar to that of FIG. 2. However, FIG. 8 shows that a torque converter 49 can be disposed between engine 14 and transmission 16, and further illustrates the dropped drive line power train of the present invention.

As indicated above, one aspect of this invention is that it uses components that have been commercially available and used for a long time, except for the step down power transfer case 30. In addition, the technology to make the step down power transfer case 30 is readily available. Accordingly, the power transfer case can be readily made at low cost, and the durability risks over a typical four-wheel drive power transfer case are not significantly increased. Still further, most of the power train components of the improved vehicle are the same as previously used to make prior art vehicles, and are still being used to make prior art vehicles. Hence, a vehicle manufacturer can use flexible assembly techniques to readily assemble both the prior art type of vehicle and the improved vehicle of the present invention from a substantially common stock of components. In some instances, only the step-down power transfer case 30 and a shorter drive shaft might be needed. In others, the half-shaft differential and swing axles might have to be stocked too. However, half-shaft differentials and swing axles are readily commercially available, and have had a long use and durability experience. They do not require a new inventive design or manufacturing technique that introduces unexpected durability and/or sales risks to the vehicle manufacturer.

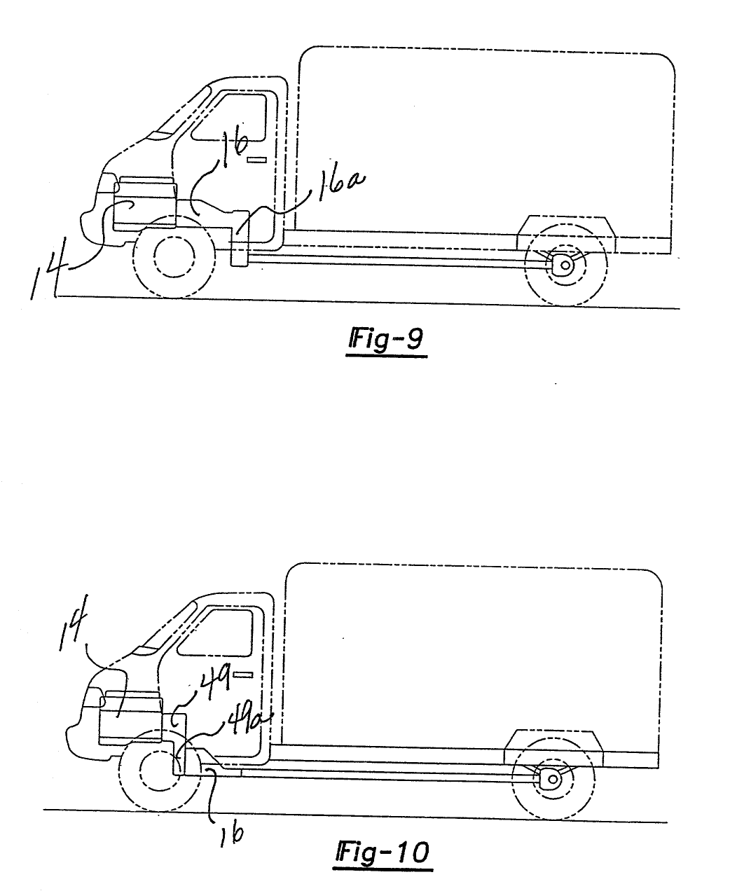

On the other hand, it is contemplated that the invention could eventually be very extensively used. If extensively used by one or more vehicle manufacturers, such use could economically justify redesigning a transmission 16 and/or a torque converter 49 to integrate the step-down power transfer case 30. FIG. 9 illustrates such a redesigned transmission 16 in which the rear part 16a of transmission 16 includes an integral step-down power handling portion that is functionally equivalent to the step down power transfer case 30. In such instance a separate step-down case 30 would not be needed.

FIG. 10 illustrates that in some instances, the power step-down function of the step-down power transfer case 30 might alternatively be integrated into the back end 49a of a torque converter 49 disposed between engine 14 and transmission 16.

It is to be appreciated that if an especially low load floor is desired, a low profile rear drive and or rear suspension system must be used with the step-down power transfer case 30. However, not all vehicles will demand the lowest load floor. For example, the vehicle manufacturer might think that there was a market for an only moderately lowered load floor vehicle because such a vehicle could be manufactured and sold at lower cost than a vehicle with a fully lowered load floor. This might be especially true if that manufacturer were also concurrently manufacturing a vehicle like that shown in FIG. 1. In such instance, the manufacturer might want to take economic advantage of using the usual unitary rigid differential/axle assembly and ordinary leaf springs, instead of taking technical advantage of a more expensive low profile rear drive and/or rear suspension. If so, the vehicle manufacturer might choose to use only the step-down power transfer case 30. FIGS. 11 and 12 show a truck bus that is a combination of the prior art truck/bus shown in FIG. 1 and the improved truck/bus shown in FIG. 2. Like FIG. 2, the truck/bus of FIGS. 11-12 has an in-line front engine 14 and transmission 16 providing power to the step-down power transfer case 30, which outputs power to drive shaft 18. However drive shaft 18 connects to a conventional rigid differential/axle unit 20/22, such as contemplated in the prior art truck/bus of FIG. 1. In addition, the rear suspension system is an ordinary leaf spring suspension system, such as contemplated in the prior art truck/bus of FIG. 1. In such a suspension system, a pair of longitudinally oriented leaf springs 62 and 64 is respectively affixed to opposed axles 22 of the rigid differential/axle unit. Leaf springs 62 and 64 are flexibly attached to the vehicle frame or load floor in a usual manner.

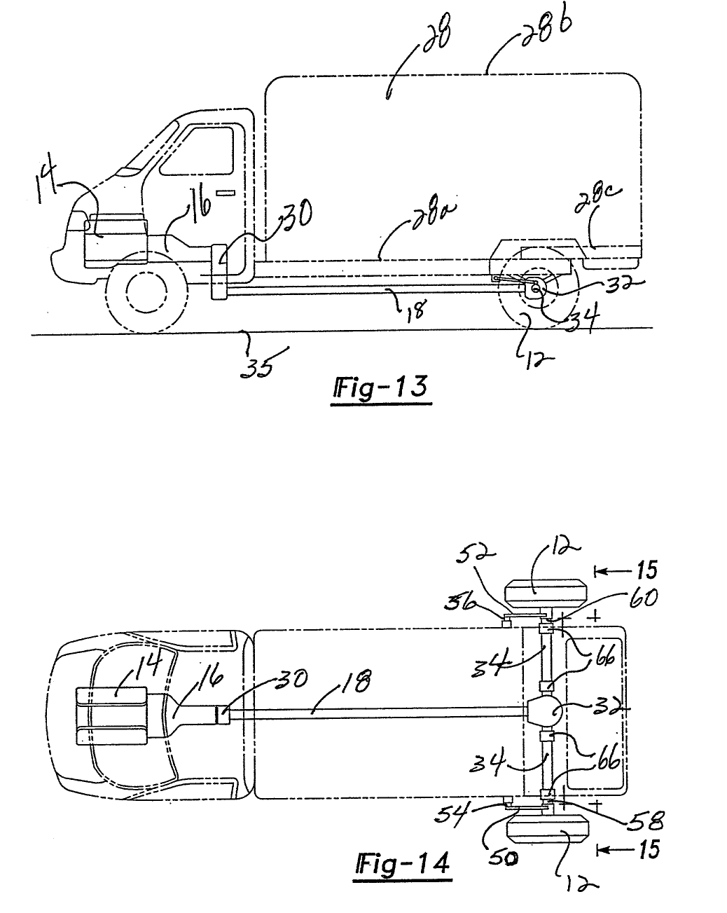

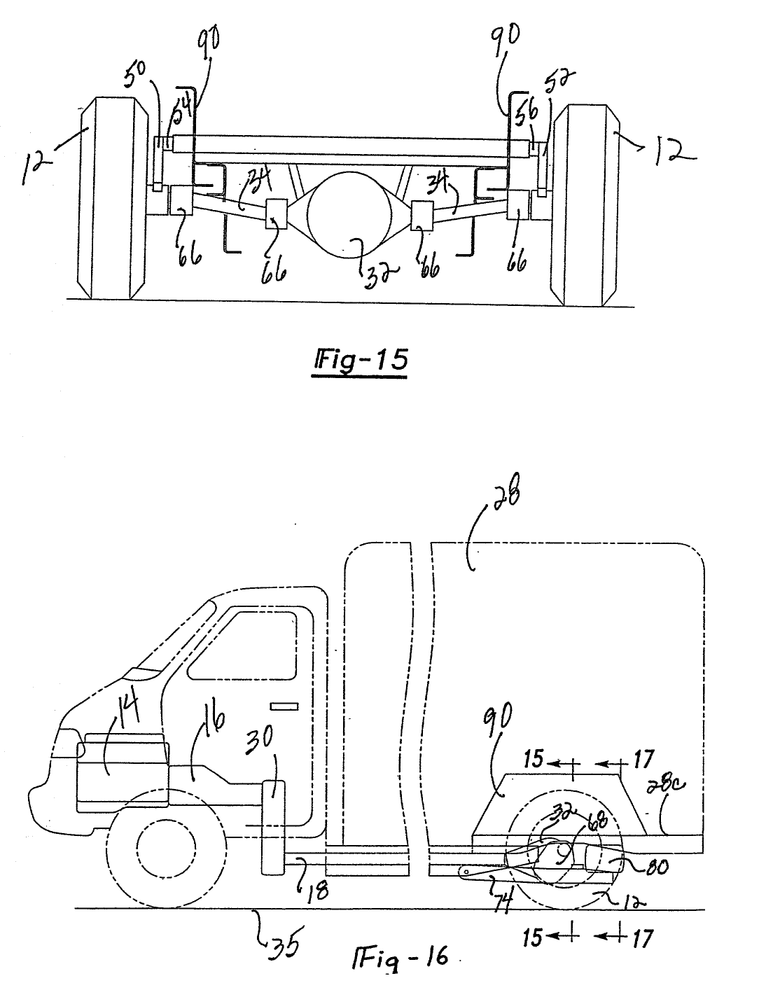

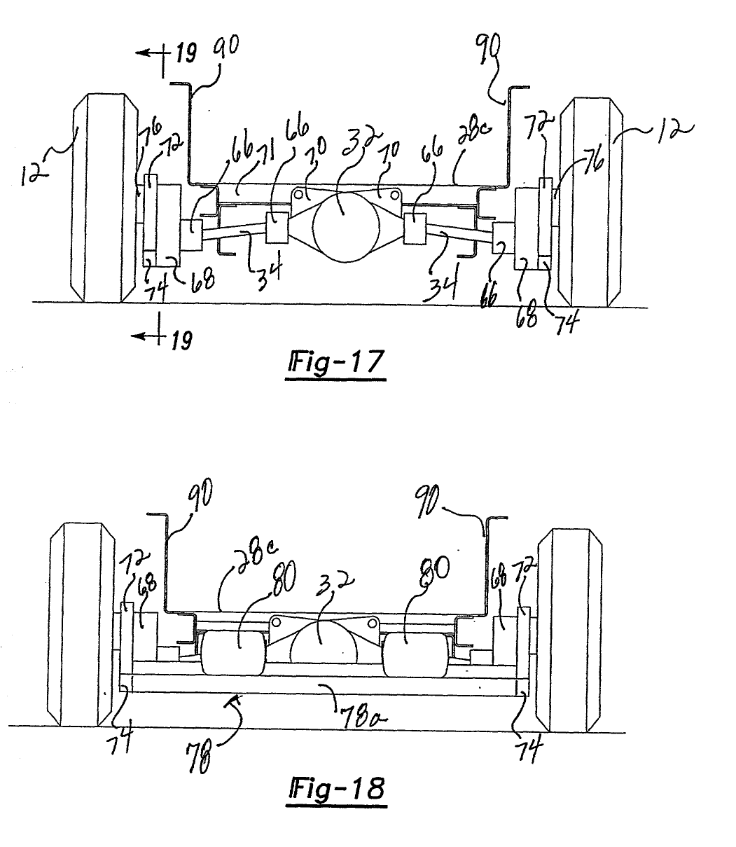

FIGS. 13-15 illustrate a lower profile embodiment for a vehicle than that shown in FIGS. 11-12. FIGS. 13-15 show a vehicle that includes a very simple form of a low profile rear suspension system in addition to a power train that has a half-shaft differential and swing axles. In FIGS. 13-15, the vehicle has a longitudinally mounted engine 14 and transmission 16, step-down power transfer case 30, drive shaft 18, a half-shaft differential 32, and swing axles 34. Swing axles 34 each have a constant velocity universal joint 66 at their inner and outer ends. The rear suspension includes trailing arms 50 and 52 that are respectively affixed to the outer ends of torque rods 54 and 56 transversely mounted on the vehicle frame or load floor. As torque rods 54 and 56 twist, trailing arms 50 and 52 rotate about the twist axis of the torque rods. This provides resilient support for the trailing arms 50 and 52. Trailing arms 50 and 52 in turn support axles 58 and 60, on which rear wheels 12 are rotatably mounted. Trailing arms 50 and 52 can be affixed at any angle theta on the ends of torque rods 54 and 56. Axles 58 and 60 can be at any location on, above, or below the trailing arms. If the axles are to be located above or below trailing arms 50 and 52, plates would be respectively welded above or below the control arms 50 and 52, to support the axles 58 and 60. Thus one can adjust the location of axles 58 and 60 to be in any desired plane with respect to the plane of load floor 28a, and at any distance from the trailing arm pivot point on the torque rods 54 and 56. In this manner, load floor 28a can be at any desired nominal height above roadway 35, and ride softness or load capacity can be at any desired level. Axles 58 and 60 would most likely be located at or slightly below the load floor 28a, especially if 16-18 inch diameter rear wheels 12 are used. Referring now specifically to FIG. 15, it should be mentioned that precise support of the plates supporting axles 58 and 60 is not shown. However, it can be seen that differential 32 and universal joints 66 are larger in diameter than in the next embodiment of this invention that shown in the following FIGS. 16-19. The reason for this will be more fully described in connection with the description of FIGS. 16-19. In short, however, the reason is that the ring gear and carrier in differential 32 and the universal joints on axles 34, as well as axles 34 themselves, have to be of large enough diameter to carry the torque loads to the rear wheels. As will also be mentioned, these issues affect frame clearances of the axles and universal joints, and ground clearances of the differential. Both of these factors would raise minimum allowable load floor height, and the attendant overall height of the vehicle if it was desired to have the load floor flat all the way to the back of the vehicle. For example, vehicle loads of about 20,000-30,000 pounds, the ring gear (not shown) in differential 32 would have to be about 13-14 inches in diameter. The case on differential 32 would have to be correspondingly bigger. Perhaps the case of differential 32 might be about 18 inches. If a differential ground clearance of 4 inches is desired when the vehicle is loaded, an unloaded ground clearance of about 6 inches might be required. This might dictate a rear load floor height of about 24 inches in the step up 28c.

On the other hand, in many instances it may be acceptable to have a step up 28c in the load floor 28a over the differential area, and then have the load floor 28c be flat all the way to the back of the vehicle. Such a step up 28c in the load floor 28a is shown in the side view of FIG. 13. Moreover, it may be desirable to have a significant step up 28c in the rear of the vehicle for other reasons, as for example to provide under-floor space between frame members for location of a fuel tank 68 or other vehicle accessories. A step up 28c may be needed in the rear of the vehicle frame merely to provide added ground clearance at the rear of the vehicle. The added ground clearance would be needed if main load floor 28a were particularly low, so that the vehicle can back up without the vehicle frame striking high curbs. It might also be desired to allow the vehicle to enter inclines such as driveways without striking its rear on roadway 35. This is particularly important if the vehicle has a significant overhang behind its rear wheels.

FIGS. 16-19 show the lowest load floor embodiment of a vehicle in this description. The load floor 28a of the vehicle shown in FIGS. 16-19 is so low that a step up 28c in the load floor will probably be required at the rear of the vehicle for the practical reasons outlined in the preceding paragraph. However, in the FIGS. 16-19 embodiment of this invention, the step up 28c in the load floor need not be very much if the vehicle has little rear overhang. The reason why the step up 28c can be smaller in this embodiment will become more apparent from the following discussion.

FIGS. 16-19 show a medium duty truck/bus analogous to that shown in FIG. 2. It has an in-line front engine 14 powering a longitudinally mounted transmission 16. Transmission 16 in turn powers a step-down power transfer case 30 that is connected to the front end of drive shaft 18 by a universal joint. The rearward end of drive shaft 18 is connected to a half-shaft differential 32 by means of a universal joint. Half-shaft differential 32 has a three point mounting to the vehicle frame. Two of the mounts are ears 70 on the top main bulb of the half-shaft differential 32 that are bolted to a transverse beam 71 of the vehicle frame. The third mount is an ear (not shown) on the front of the differential that is bolted to another transverse beam of the vehicle frame. Half-shaft differential 32 is connected to inner ends of opposed swing axles 34 by means of universal joints 66. Axles 34 have universal joints 66 at their outer ends that respectively connect the outer ends of axles 34 to input shafts low on the inside faces of step-up gearboxes 68. Step up gearboxes 68 are geared reduction wheel end drives that will hereinafter be described in greater detail. Gearboxes 68 are supported on plates 72 that are carried on a pair of trailing arms 74 of a low profile rear suspension system. The forward ends of the trailing arms 74 are pivotally mounted to the vehicle frame. One trailing arm 74 is mounted on one side of the vehicle and the other trailing arm 74 is mounted on the other side of the vehicle. Each gearbox has an output shaft high up on its outer face that extends through mounting plate 72. The gearbox output shaft forms axle 76, on which rear wheel 12 is mounted.

A torque box 78 connects trailing arms 74. This torque box/trailing arm suspension system is described and claimed in U.S. Pat. No. 6,142,496, issued Nov. 7, 2000, entitled “Low Load Floor Trailer and Suspension System”, and which is hereby incorporated in this specification by reference. As in U.S. Pat. No. 6,142,496, torque box 78 is formed by a parallel pair of mutually spaced transverse beam members 78a and 78b that extend from one trailing arm 74 to the other and are rigidly connected to inside faces of the trailing arms 74. It is anticipated that the torque box 78 be tunable by varying the size and shape of the overall construction. Tuning the torque box 78 enables improvement of noise, vibration and harshness (NVH) characteristics of the overall vehicle for providing a smoother, more comfortable ride. Also, the torque box 78 can be reinforced as for example by plates on the upper and/or lower faces of the torque box, and/or with diagonal bracing on those faces.

Alternatively, the torque box 78 may be substituted by twist beam system including a U-shaped, transverse twist beam that is tunable (i.e. may be sized differently) for roll stiffness. More specifically, a solid rectangular beam is disposed through the twist beam, and fixedly attached to the frame rails. The solid rectangular beam is preferably made of steel and is sizable to “tune” for the desired roll stiffness.

A pair of air bags 80 provides resilience to the suspension system. The air bags 80 are disposed on the upper face of torque box 78 under the load floor 28c of the vehicle, or alternatively under a transverse beam of the vehicle frame. Flexing of the trailing arms 74 squeezes air bags 80 between the torque box 78 and the load floor 28c or the transverse frame beam, to provide resiliency to the suspension.

U.S. Pat. No. 6,142,496 specifically describes a torque box/trailing arm low profile suspension system for a trailer. The suspension system includes trailing arms, a torque box 78 that includes the trailing arms, air bags 80 between the torque box 78 and the underside of the trailer load floor 28c, and wheel axles mounted on plates extending up from the top surface of the trailing arms 74. Hence, it is similar to the suspension system described above regarding FIGS. 16-19. However, in U.S. Pat. No. 6,142,496, the torque box 78 and air bags 80 are described as being forward of the wheel axles. The embodiment of this invention shown in FIGS. 16-19 differs in that the torque box 78 and air bags 80 are aft of the axles, in order to accommodate differential 32, axles 34, and step-up gearboxes 68. In addition, the axles 34 have geared reduction end drives 68, in which the output is a step up from the input. This step up allows lower positioning of the differential 32, and/or higher positioning of Wheels with respect to the load floor 28a. As can be specifically seen in FIGS. 16-19, the tops of gearboxes 68 are angled to the vehicle rear. This allows differential 32 to be moved forward, which in turn allows the torque box 78 to be moved forward. As shown, it is moved forward enough to be forward of the rearmost outer profile of rear wheels 12. Accordingly, if the vehicle backs up to a curb, rear wheels 12 will strike the curb, not torque box 78 of the rear suspension system. Thus, the tilt of the gearboxes 68 provides protection of torque box 78 from inadvertent vehicle backup injury. In addition, when tilted as shown, the bottom of gearboxes 68 need not be as close to roadway 35. It should be noted that if air were released from air bags 80, the rear of the vehicle would rest closer to roadway 35, commonly referred to a “kneeling”. In accordance with the present invention, releasing air from air bags 80 lowers the rear of the vehicle, which can facilitate loading the vehicle from the rear.

It should further be noted that the forward-oriented gearboxes 68 enable lowering of lowering of the input point of the halfshafts between the wheel and differential 32. In this manner, a reduction in the travel of the halfshafts is seen, which is proportional to the travel of the wheels, depending upon their position along the trailing arm 74. This reduction in travel can be up to 50%, and further facilitates lowering of the load floor height.

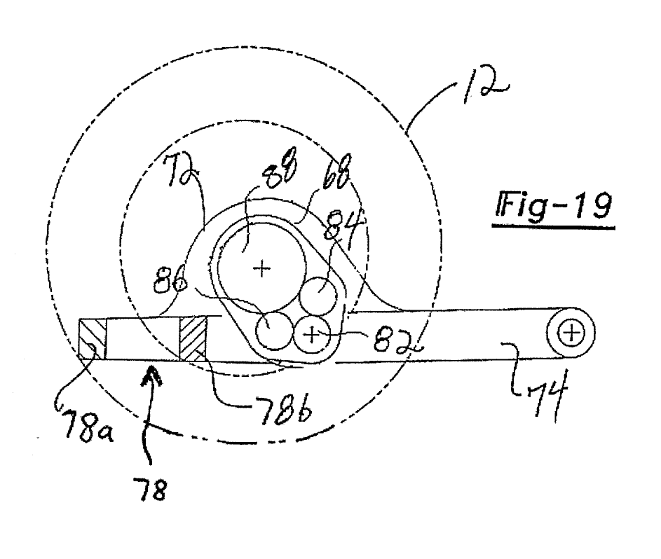

FIG. 19 is an enlarged schematic view showing the left trailing arm 74 of the suspension system as viewed looking out from between the wheels. On the right side, the view would look the same but in mirror image. FIG. 19 shows step-up gearbox 68 is mounted on a plate 72 supported on trailing arm 74. This view includes a vertical section through the step-up gearbox 68. The vertical section of gear box 68 shows that the input shaft of each gear box 68 has a gear 82 that drives two similar gears 84 and 86. Gears 84 and 86 in turn drive a large pinion 88, which is on the gearbox output shaft. Implementation of the smaller gears 84 and 86 provides a torque split, enabling a reduction in the width of the gears involved. In general, to handle the potential torque loads, the pinion 88 and smaller gear 82 would need to be approximately 4 inches in width, if in direct engagement. However, through the torque split provided by the gears 84 and 86, the width of the gears can be reduced to approximately 2 inches. As indicated above, the gearbox output shaft forms the axle for rear wheel 12. Since pinion 88 meshes with both of gears 84 and 86, tooth loading is split between them. For this reason the smaller gear 82 is able to handle the torque required for driveability of a medium duty truck/bus. This dual drive path enables reduced intrusion of the gearboxes 68 into the cargo space between the wheels.

The purpose of gearbox 68 is to reduce the torque handled by the differential and by the constant velocity universal joints 66. If the ratio of drive shaft rotation speed to axle rotation speed is high, torque on the ring gear inside differential 32 is high. If this ratio is reduced, the torque forces are reduced. In such instance, differential 32 can have a smaller diameter ring gear and be less massive. For analogous reasons, axles 34 and universal joints 66 can be less massive, and particularly of smaller diameter. This effectively allows lowest load floor designs, because the step up 28c in the rear oaf the vehicle can be made smaller. In other words, incorporation of geared reduction in step-up gearboxes 68 in the drive line aft of the differential, permits torque to be split between the gearboxes and the differential, which permits use of a less massive differential 32, less massive universal joints 66, and less massive axles 34. For comparison with FIGS. 13-15, for carrying 20,000-30,000 pound loads, an 8-9 inch ring gear might be used. This decidedly shrinks the size of differential 32. If less massive universal joints are used, less clearance is needed in the frame to accommodate axle vertical swing during loading and unloading of the vehicle suspension as the vehicle travels down roadway 35. In this latter connection, FIGS. 16-19 show a vertical thinning of the vehicle frame over axles 34 to accommodate such axle vertical swing. FIGS. 16-19 also show a structural inner fender 90 over the thinned area of the frame, which serves as a frame reinforcement. In summary, the less massive axles 34 and universal joints 66 reduce the need for allowing space for their vertical swing. This means that the frame, i.e., the load floor can be lower to the ground and/or the need for frame reinforcement is less. Both contribute to a weight savings, which can reduce manufacturing and operating costs of the vehicle. Since this is unsprung weight, reducing it improves vehicle ride.

In other words, and in greater detail, to obtain the lowest potential load floor 28c over the rear differential the drive reduction to the rear wheels is split between the fixed half-shaft differential unit 32 and the gearboxes 68 at the axle outer ends. The purpose of combining drive reduction between these components offers several advantages. Conventional rear differentials used in vehicles in this weight class provide drive reduction ratios that range from 4.00 to 1 up to 5.5 to 1 or greater. Differentials and rear axles which have ratios like these require a large ring gear to react the vehicle drive torque. When the drive mechanism splits the ratio in half, with about one half of the drive reduction occurring at the differential unit 32 and the other half occurring at each gearbox 68, differential 32 will be ½ or less of the conventional unit, or 2.0:1 to 2.75:1. This permits use of a smaller diameter ring gear to achieve this ratio without sacrificing driveline durability. Additionally because the remainder of the drive ratio is achieved at the step-up gearboxes at the axle ends, the output shafts of the differential, i.e., axles 34, are required to transmit ½ or less of the wheel drive torque of the vehicle. This further reduces the torque demand of the differential which permits additional down sizing and added durability.

Still more specifically, axles 34 transmit torque to the rear wheels through a geared drive mechanism mounted to, or integral with the wheel end carrier. This geared drive accomplishes additional benefits. First the geared drive allows the axles 34 to be located below the normal wheel center, so that the axles 34 and their universal joints 66 can be more conveniently packaged below the low load floor 28c of the vehicle. Repeating to some extent the comments made above, the indexing of step-up gearboxes 68 permits optimal placement of suspension components under the low load floor. These geared wheel end drives 68 also allow easy ratio changes without requiring tooling of additional differentials. The portion of the final drive ratio provided by these geared drives 68 effectively reduces the torque by an amount equal to the portion of the ratio contained in the geared wheel end drive. For example, a final drive ratio of 5.0:1 achieved by using a 2.5:1 differential in combination with a 2.0:1 geared wheel end drive will be required to transmit only ½ the output shaft, i.e., axle shaft, torque as a final drive system that uses a conventional 5.0:1 differential directly connected to the rear wheel ends, as in FIGS. 13-15. It is thus seen that if differential 32 provides the complete final gearing as in FIGS. 13-15, the load floor at the rear differential would need to be several inches higher than the system which splits the ratio between the differential and geared wheel end drives.

While a specific low load floor rear suspension system has been described above, it should also be noted that other low load floor suspensions are known. For example, U.S. Pat. Nos. 4,878,691 to Cooper et al., U.S. Pat. No. 4,934,733 to Smith et al., U.S. Pat. No. 5,016,912 to Smith et al., and U.S. Pat. No. 5,275,430 to Smith, describe other low load floor suspension systems for trailers. Each of these disclosures is incorporated herein by reference. It is anticipated that these latter, unpowered suspension systems be powered, using the principles of the present invention, and be substituted for the powered low load floor suspension system described herein.

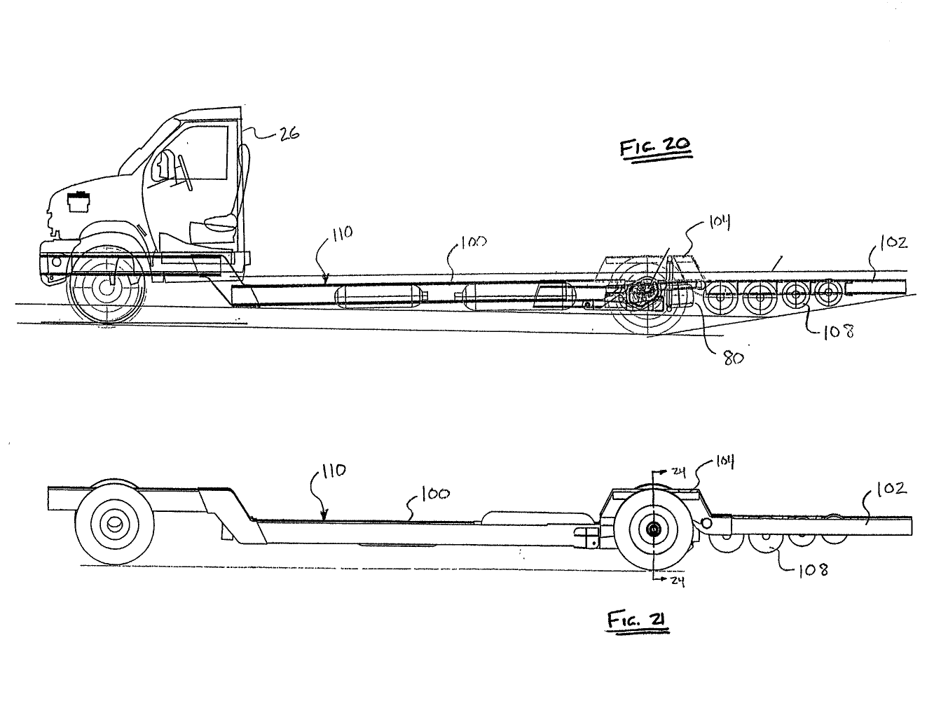

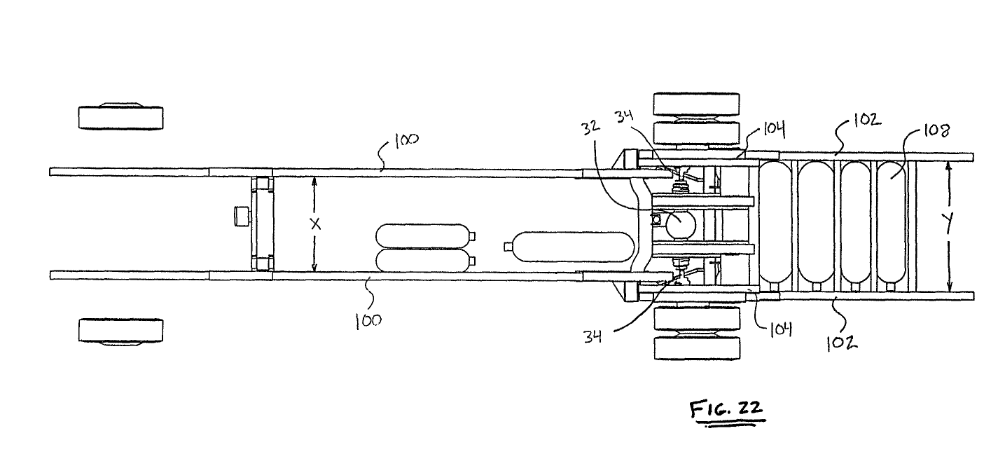

With reference to FIGS. 20 through 24, an alternative embodiment of the vehicle will be described in detail wherein like characters represent the same or corresponding components to those previously discussed. The vehicle includes side frame rails 100 extending back from driver's cab 26 for engagement with adjacent frame rail extensions 102. Intermediate frame rails 104 are provided for interconnecting the side frame rails 100 and the frame rail extensions 102. A distance X is defined between the side frame rails 100 and a distance Y is defined between the frame rail extensions, wherein the distance X is generally less than the distance Y. There are distinct advantages in the width variation between the side frame rails 100 and the frame rail extensions 102. The narrowly spaced side frame rails 100 are spaced for mating with driver cab 26 frame rails set at industry standard width. Further, the narrowly spaced frame rails 100 provide space at either side for mounting a unit, such as an air-conditioning unit (not shown) underneath the vehicle. This results in significant cost savings as opposed to roof-mounted air conditioning units. Further, the increased space between the frame rail extensions 102 enables implementation of a longer fuel or natural gas tanks 108. In this manner, sufficient fuel can be stored between protective frame rails, meeting government safety requirements.

With particular reference to FIGS. 20 and 21, a frame assembly 110, comprising side frame rails 100, frame rail extensions 102 and intermediate frame rails 104, slopes upwards as the frame assembly 110 runs back. In this manner, a front portion of the frame assembly 110 is closer to the ground than a rear portion of the frame assembly 110. With the front portion of the frame assembly 110 closer to the ground, a ramp (not shown) may be installed having a manageable slope for wheelchair access. This eliminates the need for a complex, expensive elevator system, as discussed above. In addition to lowering the front portion of the frame assembly 110 for manageable use of an access ramp, the sloping frame assembly 110 eliminates the need for a step, such as step 28c of FIG. 13. Concurrently, the slope of the frame assembly 110 enables sufficient rear clearance to ensure the vehicle clears any curbs or other potential obstacles.

It may be desired that the higher rear portion be lowered in certain instances, such as loading and unloading from the rear portion, for increased ease in accessing the rear portion. To achieve this, the air bags 80 may be selectively deflated to lower the rear portion for enabling easy access thereto.

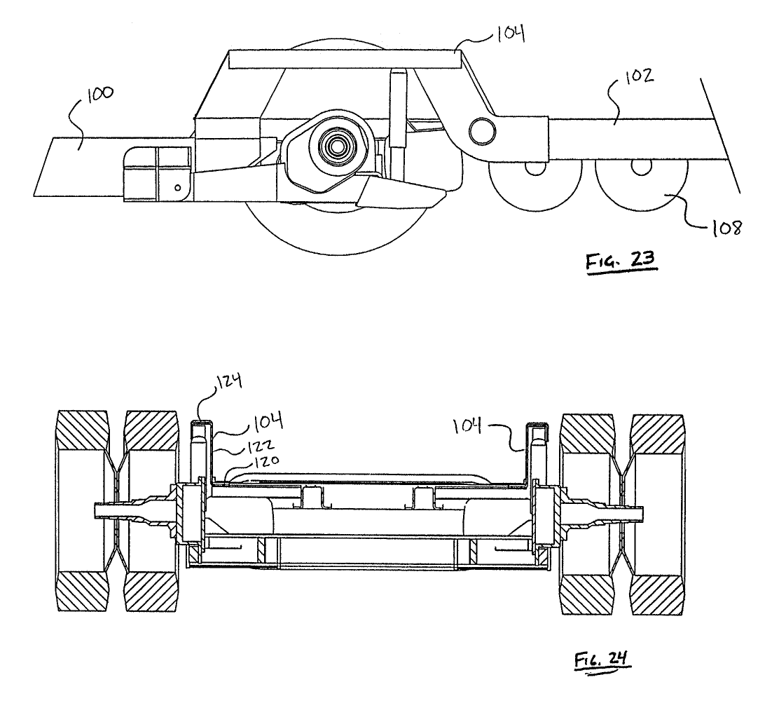

With particular reference to FIGS. 23 and 24, the intermediate frame rails 104 are generally provided as a frame segment, each including a generally Z-shaped cross-section having a bottom length 120, an intermediate length 122 and a top length 124. The bottom length 120 extends laterally inboard and the top length 124 laterally outboard. The side frame rails 100 are interconnected with an inboard side of the intermediate frame rails 104 and the frame rail extensions 102 are interconnected with an outboard side of the intermediate frame rails 102. In this manner, the Z-shaped cross-section of the intermediate frame rails 104 established the distances X and Y, as between the side frame rails 100 and the frame rail extensions 102, respectively. In other words, the Z-shaped cross-section enables widening of the rear portion for implementation of the longer fuel or natural gas tanks 108, as discussed above. Further, the Z-shaped cross-section enable a wider passenger walk through between the wheels.

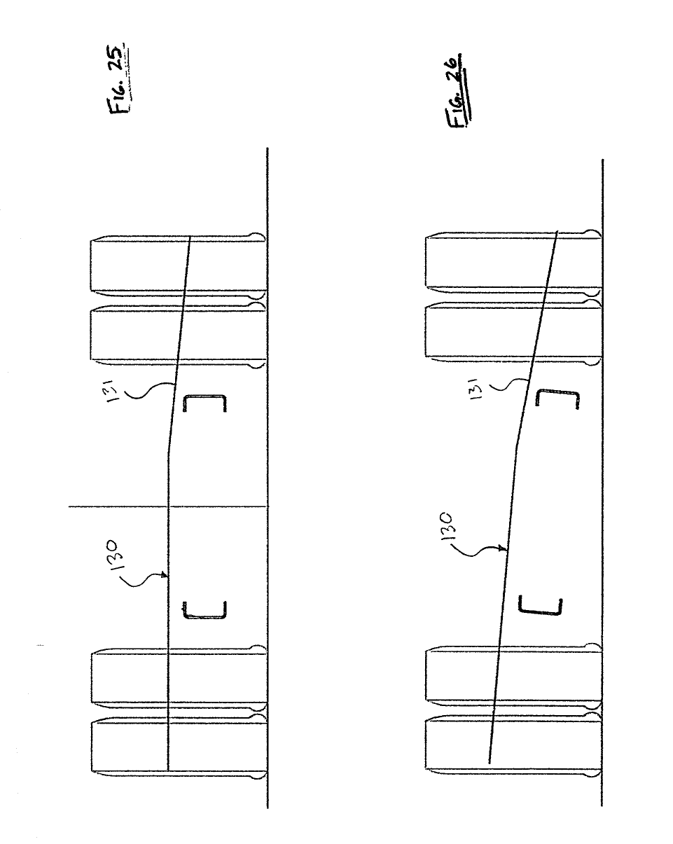

To further improve ramp accessibility, a floor 130 of the vehicle may be sloped towards one or both sides, as shown in FIGS. 25 and 26. A downward slope 131 of the floor 130 lowers the height of the floor to the ground. In this manner, the slope and length of an access ramp leading therefrom may be reduced, making the access ramp more manageable. Further, as shown in FIG. 26, the air bag 80 on the slope-side of the floor 130 can be deflated to lower the floor 130 towards the ground, thereby further improving accessibility.

With particular reference to FIGS. 27 and 28, the stability provided by the torque box 78 may be assisted by including supplementary suspension components. Specifically, a track bar or “panhard” rod 200 is preferably implemented for improving the lateral stability of the vehicle. In a first preferred embodiment (see FIG. 27), the panhard rod 200 is operably attached between the intermediate frame rail 104 and a cross-axle beam (hidden) interconnecting the trailing arms 74. The intermediate frame rail 104 includes a pivot bracket 202 fixed thereto and to which the a first end of the panhard rod 200 is pivotally attached. A second end of the panhard rod 200 is pivotally attached to a face of the cross-axle beam. In this manner, as the opposing intermediate frame rails 104 are caused to move relative to one another, the panhard rod 200 enables further stability therebetween. In a second preferred embodiment (see FIG. 28), a dual panhard rod system is provided, configured as a “UVatts” link 210. The Watts link 210 includes a central pivot link 212 pivotally supported on a central differential carrier 214, and panhard rods 216 pivotally attached thereto and extending therefrom for attachment to the cross-axle beam.

It should also be mentioned that the Figures of the drawing are not necessarily to scale or correct in relative proportions. They have been prepared for illustration of the points discussed in this specification, not as working drawings. for example, no shock absorbers are shown in the drawings. However, most suspension systems will include them. As further example, in the trailing arm suspension of the FIGS. 13-15 and FIGS. 16-19 embodiments, one end of a shock absorber would be mounted on each trailing arm. The other end of the shock absorber would be attached to an adjacent part of the vehicle frame or reinforced part of the vehicle body. In the FIGS. 16-19 embodiment, the other end of the shock absorber might alternatively be attached to the structural inner fender 90. Such a mount is analogous to the trailer sidewall mount shown in the abovementioned U.S. Pat. No. 6,142,496.

While the invention has been described in the specification and illustrated in the drawings with reference to specific preferred embodiments, it will be understood by those skilled in the art that various changes may be made and equivalents may be substituted for elements thereof without departing from the scope of the invention as defined in the claims. In addition, many modifications may be made to adapt a particular vehicle or component thereof to the teachings of the invention without departing from the essential scope thereof. Therefore, it is intended that the invention not be limited to the particular embodiments illustrated by the drawings and described in the specification as the best mode presently contemplated for carrying out this invention, but that the invention will include any embodiments falling within the description of the appended claims.

What is claimed:

1. A vehicle having a powered low profile drive line, comprising:
a frame assembly extending from a front end of the vehicle to a rear end, said frame assembly sloping upward relative to horizontal and including a first set of parallel frame rails offset a first distance and a second set of parallel frame rails offset a second distance and attached to said first set of parallel frame rails;
an engine supported by said frame assembly and having a power output;
a power transfer device having a transfer input operably attached to said power output and a transfer output axially offset from said transfer input;
a driveshaft operably attached to said transfer output, said driveshaft substantially horizontal along a length of said frame assembly;
a drive operably attached to said driveshaft for enabling power transfer thereto; and
a low profile suspension resiliently supporting rear wheels relative to said frame assembly such that said rear wheels move vertically with respect to said frame assembly.

2. The vehicle of claim 1, further comprising a transmission for receiving engine power and providing various output ratios of engine power, said transmission disposed between said engine and said power transfer device so as to receive engine power from said power output and deliver selected ratios of said power output to said transfer input of said power transfer device.

3. The vehicle of claim 1, wherein said drive includes a differential to which said drive shaft is operably interconnected, said differential is connected to said rear wheels of the vehicle.

4. The vehicle of claim 3, wherein said differential is a half-shaft differential immovably supported by said frame assembly, and opposed swing axles extend from said differential unit.

5. The vehicle of claim 4, wherein said differential is a low profile differential including step-up gear drives connecting outer ends of said swing axles to said rear wheels of the vehicle.

6. The vehicle of claim 1, wherein said low profile suspension includes a pair of trailing arms pivotally mounted to said frame assembly, a torsion box including first and second transverse beam members secured between said trailing arms beneath said frame assembly, a pair of air springs compressed between said torsion box and said frame assembly for urging said frame assembly upward from said torsion box, and wheel supports extending upwardly from said trailing arms, each wheel support having a wheel axis supporting a portion of said rear wheel above said frame assembly.

7. The vehicle of claim 6, wherein said torsion box includes first and second transverse beam members secured between said trailing arms beneath said frame assembly, first and second plates attached to said first and second transverse beams adjacent said trailing arms, a first cross beam secured to said first transverse beam substantially adjacent said first plate and secured to said second transverse beam substantially adjacent said second plate, a second cross beam secured to said second transverse beam substantially adjacent said first plate and secured to said first transverse beam substantially adjacent said second plate, said torsion box providing lateral and longitudinal rigidity to said low profile suspension and permitting independent wheel movement by torsional displacement along said first and second transverse beams.

8. The vehicle of claim 6, further comprising a panhard rod attached between said frame member and one of said first and second transverse beams for providing rigidity to said low profile suspension.

9. The vehicle of claim 1, wherein said second distance is wider than said first distance for establishing a wider portion of said frame assembly for improved storage space therewithin.

10. The vehicle of claim 9, wherein said wider portion of said frame assembly extends behind said drive.

11. A rear drive line for a vehicle having a frame and rear wheel, comprising:
a powered drive including a half-shaft differential to which a drive shaft is operably interconnected, said half-shaft differential immovably supported by the frame assembly, and having opposed swing axles extending therefrom and including step-up gear drives connecting outer ends of said swing axles to the rear wheels of the vehicle; and
a low profile suspension including a pair of trailing arms pivotally mounted to the frame, a torsion box including first and second transverse beam members secured between said trailing arms beneath the frame, a pair of air springs compressed between said torsion box and the frame for urging the frame upward from the torsion box, and wheel supports extending upwardly from the trailing arms, each wheel support having a wheel axis supporting a portion of the rear wheel above the frame.

12. The rear drive line of claim 11, wherein said torsion box includes first and second transverse beam members secured between said trailing arms beneath the frame, first and second plates attached to said first and second transverse beams adjacent said trailing arms, a first cross beam secured to said first transverse beam substantially adjacent said first plate and secured to said second transverse beam substantially adjacent said second plate, a second cross beam secured to said second transverse beam substantially adjacent said first plate and secured to said first transverse beam substantially adjacent said second plate, said torsion box providing lateral and longitudinal rigidity to said low profile suspension and permitting independent wheel movement by torsional displacement along said first and second transverse beams.

13. The rear drive line of claim 11, further comprising a panhard rod attached between a frame member and one of said first and second transverse beams for providing rigidity to said low profile suspension.

14. The rear drive line of claim 11, wherein said step-up gear drives each include an input operably interconnected with said swing axle, an output operably interconnected with the rear wheel and a transfer assembly drivably interconnecting said input and said output, said step-up gear drives providing a gear reduction between said swing axles and the rear wheels.

15. The rear driveline of claim 14, wherein said transfer assembly includes first and second gears in meshed engagement between an input gear of said input and an output gear of said output.

16. A vehicle having a powered low profile drive and suspension, comprising:
a frame assembly extending from a front end of the vehicle to a rear end, said frame assembly sloping upward relative to horizontal and including a first set of parallel frame rails offset a first distance and a second set of parallel frame rails offset a second distance and attached to said first set of parallel frame rails;
an engine supported by said frame assembly and having a power output;
a drive operably attached to said power output for enabling power transfer thereto, said drive including a half-shaft differential to which a drive shaft is operably interconnected, said half-shaft differential immovably supported by the frame assembly, and having opposed swing axles extending therefrom and including step-up gear drives connecting outer ends of said swing axles to the rear wheels of the vehicle; and
a low profile suspension resiliently supporting rear wheels relative to said frame assembly such that said rear wheels move vertically with respect to said frame assembly.

17. The vehicle of claim 16, further comprising a driveshaft operably interconnecting said power output, said driveshaft substantially horizontal along a length of said frame assembly.

18. The vehicle of claim 16, further comprising a power transfer device having a transfer input operably attached to said power output and a transfer output axially offset from said transfer input, said power transfer device operably disposed between said engine and said drive for transferring drive power therebetween.

19. The vehicle of claim 16, wherein said low profile suspension includes a pair of trailing arms pivotally mounted to said frame assembly, a torsion box including first and second transverse beam members secured between said trailing arms beneath said frame assembly, a pair of air springs compressed between said torsion box and said frame assembly for urging said frame assembly upward from said torsion box, and wheel supports extending upwardly from said trailing arms, each wheel support having a wheel axis supporting a portion of said rear wheel above said frame assembly.

20. The vehicle of claim 19, wherein said torsion box includes first and second transverse beam members secured between said trailing arms beneath said frame assembly, first and second plates attached to said first and second transverse beams adjacent said trailing arms, a first cross beam secured to said first transverse beam substantially adjacent said first plate and secured to said second transverse beam substantially adjacent said second plate, a second cross beam secured to said second transverse beam substantially adjacent said first plate and secured to said first transverse beam substantially adjacent said second plate, said torsion box providing lateral and longitudinal rigidity to said low profile suspension and permitting independent wheel movement by torsional displacement along said first and second transverse beams.

21. The vehicle of claim 19, further comprising a panhard rod attached between said frame member and one of said first and second transverse beams for providing rigidity to said low profile suspension.

22. The vehicle of claim 16, wherein said step-up gear drives each include an input operably interconnected with said swing axle, an output operably interconnected with the rear wheel and a transfer assembly drivably interconnecting said input and said output, said step-up gear drives providing a gear reduction between said swing axles and the rear wheels.

23. The vehicle of claim 22, wherein said transfer assembly includes first and second gears in meshed engagement between an input gear of said input and an output gear of said output.
